(19) United States
(12) Patent Application Publication
(10) Pub. No.: US 2017/0124585 A1
(43) Pub. Date: May 4, 2017

(54) Reward Based Social Network Platform

(71) Applicant: Jeffrey Sullivan, Quincy, MA (US)

(72) Inventor: Jeffrey Sullivan, Quincy, MA (US)

(21) Appl. No.: 14/927,015

(22) Filed: Oct. 29, 2015

(51) Int. Cl. G06Q 30/02; G06Q 50/00

(52) U.S. Cl. CPC G06Q 30/0217; G06Q 30/0236; G06Q 30/0239; G06Q 50/01

(57) ABSTRACT

The present system relates to a computer-implemented system and method that facilitates a consumer and business social networking platform, specifically a social network rewards platform and method, in which business users provide rewards, monetary or non-monetary, to consumer users for promoting events, businesses, restaurants, and other merchants. The system and method enables a first participating consumer user to access his or her account to plan social events at participating business user locations; to make reservations at participating business user locations; to check for business user advertisements and promotions; to connect with other consumer users and to connect with business users. The system and method also enables a first participating business user to access its account to respond to consumer user reservations; to advertise and promote events occurring at the business user location; to connect with other business users and to connect with consumer users.

### CROSS-REFERENCE TO RELATED APPLICATION

This application takes priority from and claims the benefit of U.S. Provisional Patent Application Ser. No. 62/069,979 filed on Oct. 29, 2014, the contents of which are herein incorporated by reference.

### BACKGROUND OF THE INVENTION

Field of Invention

The present system and method relates generally to a social networking platform, and more particularly to a computer-implemented system and method to facilitate and reward consumers for promoting events, businesses, restaurants, and other merchants.

Description of the Related Art

Online social networking sites have rapidly grown in the past few years, with new users signing up daily to engage in a variety of different social network systems. Social networks are popular because they allow users to share their interests, activities, opinions, and other thoughts with other users and connections who are signed up for the particular social network. Common social networking sites include Facebook®, LinkedIn®, and Twitter®.

Computer users today are members of a variety of such social networks through which they are connected with a great many users. Businesses have begun to use such networks for viral marketing. Viral marketing seeks to market a product, service, event, or idea by placing the marketing content with users (usually influential users) that will distribute the marketing content to other users they are connected to. This type of marketing tends to be cheaper and more effective at reaching target audiences compared to traditional marketing schemes. For example, getting a user, who loves to eat at a neighborhood restaurant, to attend an advertised event at that restaurant and invite and bring friends to the restaurant, can be more effective at attracting new patrons than taking out thousands of dollars' worth of advertisements space for a billboard. Thus, companies tend to be very interested in leveraging users' social networks to distribute information of interest to users in the networks.

Businesses are also exploring ways to connect to prospective clientele and customers and make reward programs for loyal and repeat customers. Social network mediums through which a business can touch base with a customer and promote and advertise services are varying.

### SUMMARY OF THE INVENTION

The instant system and method, as illustrated herein, is clearly not anticipated, rendered obvious, or even present in any of the prior art mechanisms, either alone or in any combination thereof. Thus the several embodiments of the instant system and method are illustrated herein.

The present system relates to a computer-implemented system and method that facilitates a consumer and business social networking platform, specifically a social network rewards platform and method, in which business users provide rewards, monetary or non-monetary, to consumer users for promoting events, businesses, restaurants, and other merchants.

The system and method enables a first participating consumer user to access his or her account to plan social events at participating business user locations; to make reservations at participating business user locations; to check for business user advertisements and promotions; to connect with other consumer users and to connect with business users. The system and method also enables a first participating business user to access its account to respond to consumer user reservations; to advertise and promote events occurring at the business user location; to connect with other business users and to connect with consumer users.

The consumer user or business user can display interests, promotional materials, and biographical information for all users to view. They can further share information to other social network platforms by connecting other social networks to the current system. For example, a consumer user can connect his Facebook®, Twitter®, LinkedIn® account to his consumer user profile page.

After connecting to the present system, consumer users are able to host events or attend promotional events and then business users reward the consumer user for their attendance and participation in with both monetary rewards and non-monetary rewards. Consumer users are also able to provide feedback and reviews to the business users that help benefit the business users and other consumer users.

The system broadly comprises a transaction aggregator responsible for tracking activities over the social network platform, a processing engine to issue rewards, both monetary and non-monetary for every consumer user interaction with the business user, a promotion scheme to process and deliver promotions or advertised events based on a set of guidelines, predefined by the hosting business user, a database to store and track rewards, to update consumer user rewards, to store business user feedback, and record the number of consumer users and business users of the reward-based social network platform.

There has thus been outlined, rather broadly, the more important features of a system and method for a rewards-based social networking platform in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways, including applications involving not only firefighters. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIG. 1 illustrates a block diagram of an exemplary computing system for implementing a rewards-based social networking platform.

FIG. 2 illustrates a block diagram of a plurality of interfaces provided to a user engaged with the rewards-based social network platform.

FIG. 3 illustrates a block diagram of an exemplary hardware system to connect multiple users of the rewards-based social networking platform.

FIG. 4A is a flow chart illustrating one embodiment of a method to connect a consumer user and a business user via the rewards-based social networking platform.

FIG. 4B is a flow chart illustrating one embodiment of a method to connect a consumer user connections with personal third-party networks via the rewards-based social networking platform.

FIG. 5A is a flow chart illustrating one embodiment of a method to allow for business user transactions via the rewards-based social networking platform.

FIG. 5B is a flow chart illustrating one embodiment of a method to allow for consumer user transactions via the rewards-based social networking platform.

FIG. 6 is an illustration of one embodiment of the environmental operating system for all parties of the rewards-based social networking platform.

FIG. 7 is an exemplary representation of a consumer user profile page.

### DETAILED DESCRIPTION OF THE SEVERAL EMBODIMENTS

The embodiments herein provide a method and system that allows a third party (such as a business, restaurant, or organization) to securely reward users who promote the specific businesses. By partnering with businesses, the social network creates an incentive platform that allows businesses to easily create daily rewards for users. The social networking rewards platform/system provides rewards to users and affiliates for planning events, attending events, hosting events, and referring parties, including social networking contacts, to a business, restaurant, venue, event, etc. The social networking reward platform also includes a rating and review system for rating various businesses, parties, and venues. Referring to the drawings generally, the methods and systems can be implemented by use of an online computer software application operated from a computing device.

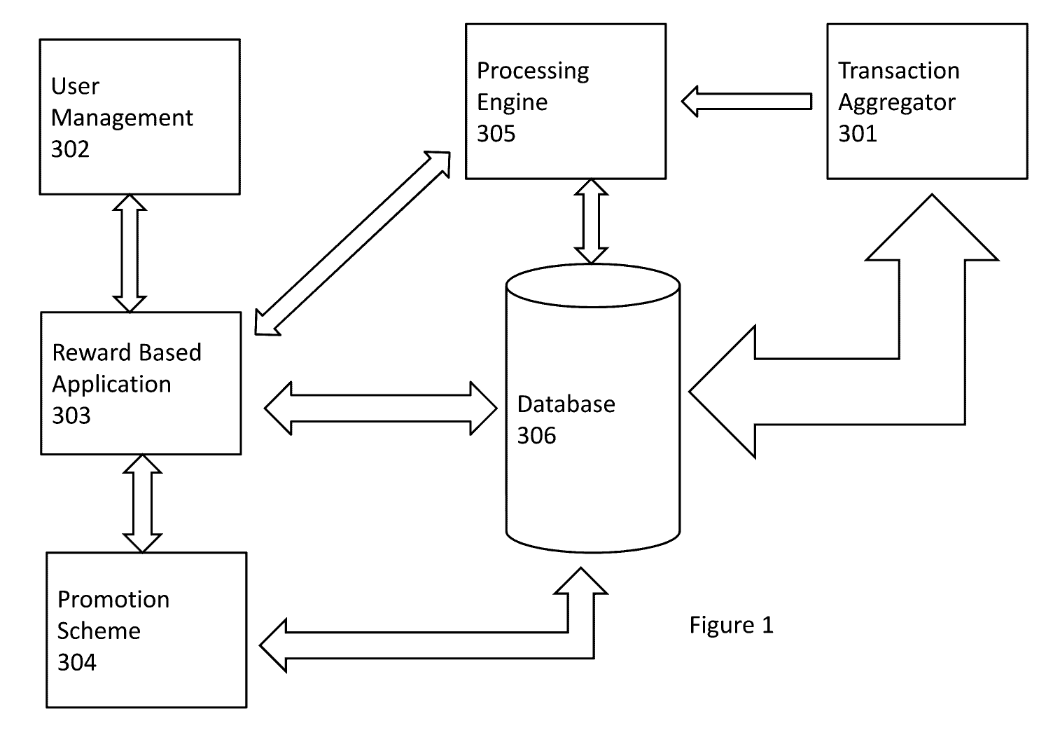

FIG. 1 illustrates a block diagram of an exemplary computing system for implementing a rewards-based social networking platform 10. Broadly, one embodiment of the computer system comprises a transaction aggregator, 301, user management 302, reward-based application 303, promotion engine 304, processing engine 305 and a database 306.

Preferably, the database 306 maintains a database of all participating users, including, but not limited to consumer users and business users. This database 306 keeps track of all social contacts within a participating consumer/business user's third-party social networks and contact within the rewards-based social networking platform. Additionally, the database 306 may keep track of all member related information, reward account information, and reward balance information.

The User Management 302 preferably manages a reward program including business user promotion programs and advertised programs where program guidelines are created by a business and rules and regulations regarding the promotion are predefined.

The Transaction Aggregator 301 accumulates all transactions and non-transactional activities recorded by the various business users. The aggregator tallies the rewards, whether point-based or monetary, due to every interaction done by any consumer user and accordingly maintains business offers and business statuses. All such interactions are stored in a database for future reference and to generate statistics that are relevant to the business user. For instance, success of a particular event, increase in promotional activity, consumer behavior, etc. are some instances that could be tracked and analyzed by the business user.

The Rewards-Based Application 303 enables members to view and manage reward accounts that are integrated within the rewards-based social networking platform. It tracks the reward related information along with an identifier that gets translated to unique code or bar code or QR code and the like on the social network.

Promotion Scheme 304 obtains data from database 306 to process and deliver promotions or deals based on certain predefined guidelines set by the business user in the social networking platform to participating consumer users. Through the reward based application, a consumer user can view promotional or advertised programs, invite other members, and share promotions.

Processing Engine, 305 works on the interactions between consumer users and business users and generates the rewards that occur for every interaction. The tally of interactions and rewards is maintained. Every change in the consumer user rewards balance due to earned, accumulated or redeemed rewards is synchronized across the user management and reward based application.

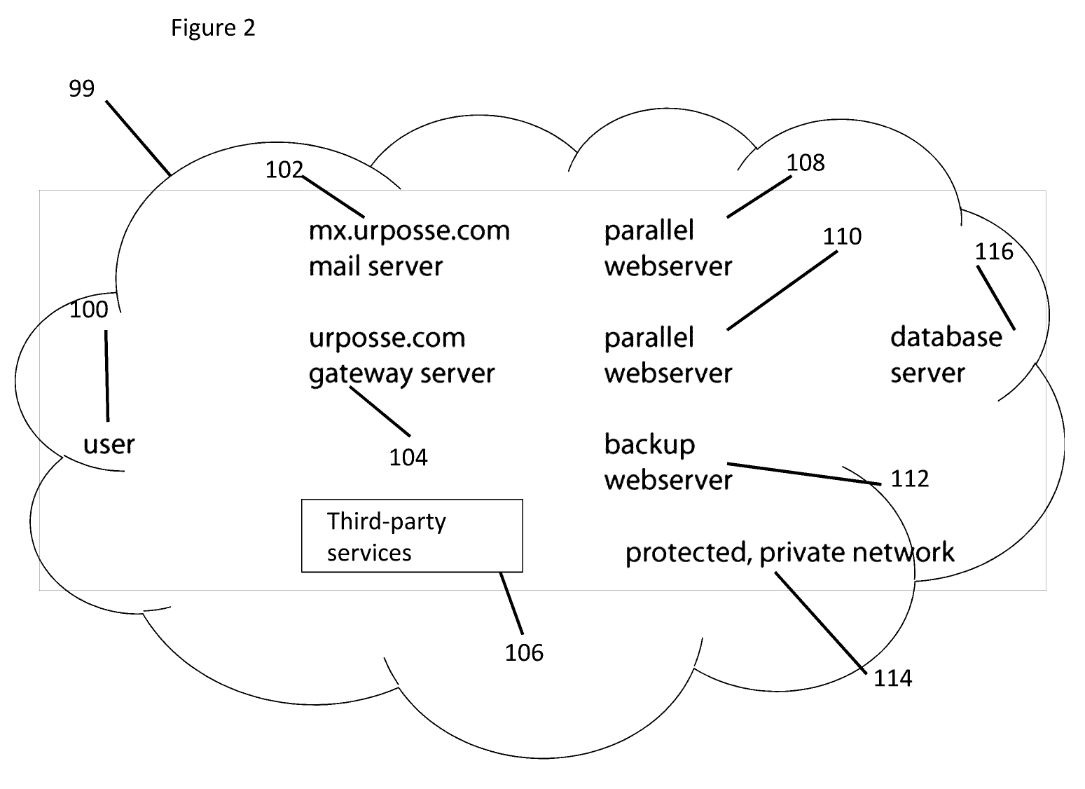

FIG. 2 illustrates the outward-facing points of access to the rewards-based social networking platform. A cloud provider, 99, having Solid State Drive hardware for storage where six virtual-machines work together in order to support the system requirements. The user, 100, interacts with the social networking platform and is able to send a variety of requests through the program.

First, web requests arrive to a front-end “gateway” machine, 104, which just analyzes the nature of the request and balances the load among webservers, 108, 110, and 112. There are three webservers, 108, 110, and 112 that are configured alike. Every database request goes through a long series of network “hops” across the internet backbone, to retrieve data for the user's requests. The backup webserver, 112, is configured to be a “backup” and not answer any requests unless the two primary, parallel webservers, 108 and 110 are both offline for some reason.

The database, 116, is optimized for data only. Here, the database server would run with tables built into the engine for good scalability, rapid indexing, and “referential integrity” to keep logical entities properly aligned. The database only interacts with the IP addresses from the social networking platform webservers, 108, 110, and 112, in effect no outside sources can gain direct access to the social networking platform data. This allows for a protected, private network, 114, between the webservers and the database server.

A mail server, 102, handles all of the social networking platforms “internal” communications. It runs on a separate machine so that no amount of email traffic, spam filtering, attachments, and downloads, or other mail related activity could slow down social networking platform user-facing site machinery. The isolated mail server is also a security safeguard to protect against viruses and malware.

The social networking platform website relies upon and integrates a wide array of third-party services, 106. As seen the user's, 100, interaction with the mail server, 102, and the gateway server, 104, then in turn with the three webservers, 108, 110, 112 and database server, 116, are a completely protected, private network from a user's outside interactions with other networks, servers, or services such as Google Cloud Storage. However, these services can still provide off-site storage for users so that the social networking platform webservers are not cluttered up and users do not need to pay extra hosting fees for bulk quantities of user-generated media. This is quite beneficial for the user because it allows all webservers to reach the users' files alike.

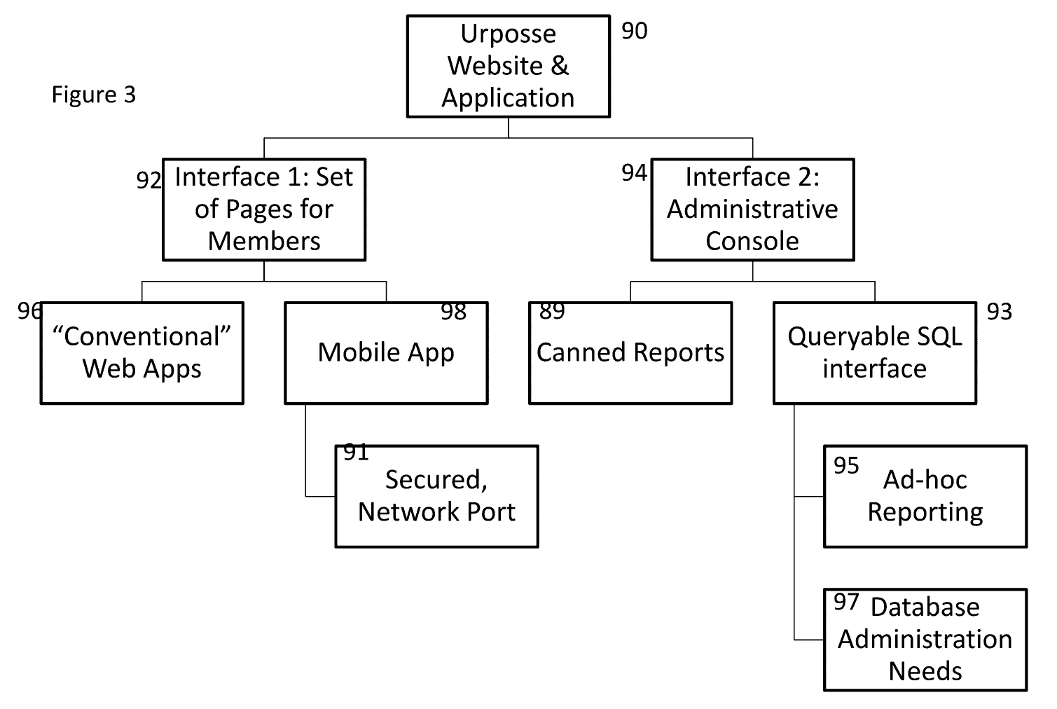

FIG. 3 describes the two primary interfaces for the social networking platform website and application, 90. The first interface, 92, is a set of pages for the end-user, a social networking platform member. The other interface, 94, is an administrative console for the licensed retailer, a social networking platform establishment. The members' are is made available not only through “conventional” web applications, 96, but also through an alternate channel tailored for delivery as a mobile app, 98. To keep each application isolated from another, all mobile traffic is conducted on a secured network port. Each navigation element, whether a link, button, form submission, menu item, javascript redirect or map dot, is made to relay its request via the port so that the server knows to strip out the header/footer content of these delivered pages, sending only the document body to the mobile app.

Under Interface 2, 94, social networking platform maintains a rudimentary set of Administrative pages which present some canned reports, 89, and a queryable SQL interface, 93, for ad-hoc reporting, 95 and database administration needs, 97. These features aid debugging, troubleshooting, and support, although it does require that the user is fluent in SQL language, and familiar with the social networking platform application's database interactions and dependencies.

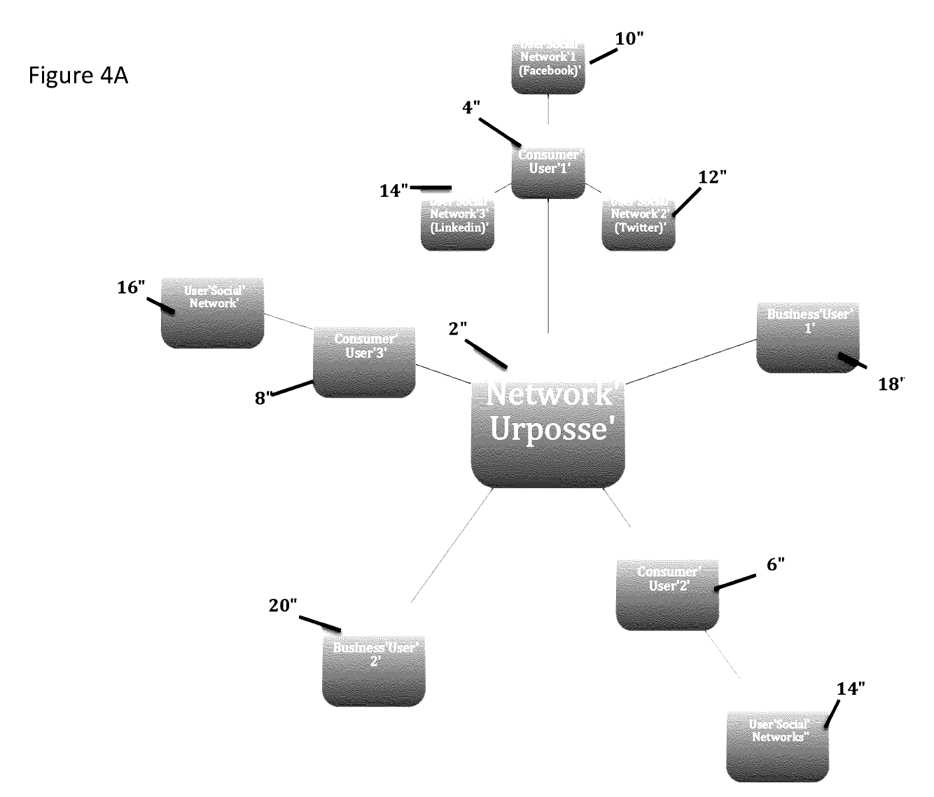

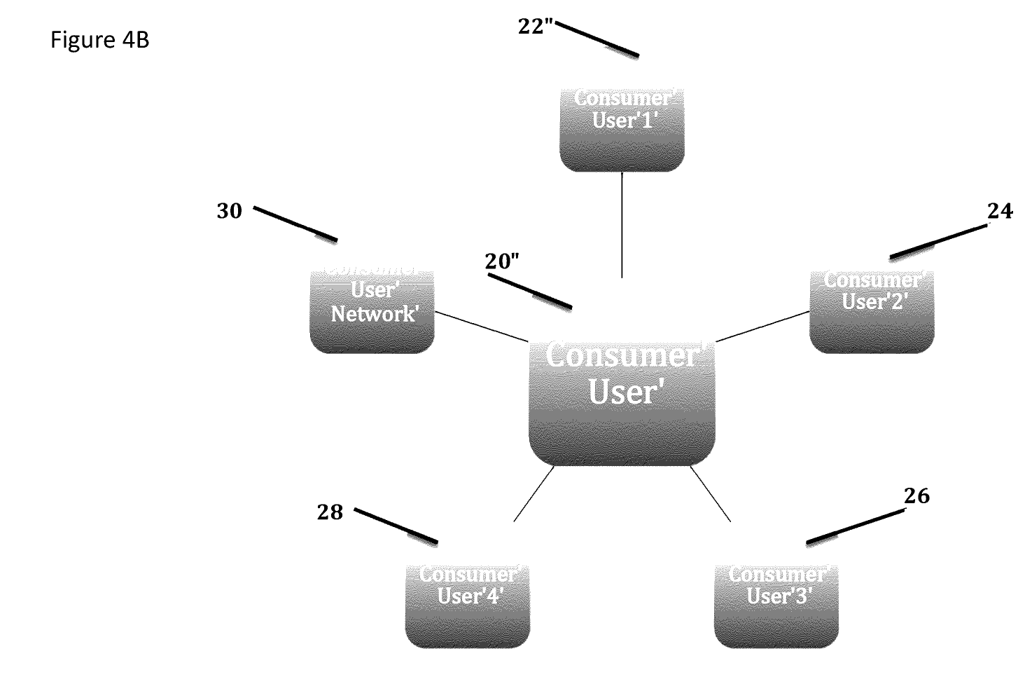

Referring to FIG. 4A and FIG. 4B, social networks allow users to form connections with other users and businesses in the social network. One or more consumer users, 4, 6, 8 connect to the social network, social networking platform 2, using a computing device. Users create profiles on the social network that includes information about the user, such as biographical information, interests or hobbies. User profiles can also include photographs and track the user's whereabouts at “checked-in times.”

Users can connect all their top social networks, 10, 12, 14, 16 into one social networking platform user account. Examples of social networks include Facebook, 10, Twitter, 12, LinkedIn, 14, and others, 14, 16.

Businesses can also connect to the social networking platform network, 2. One or more business, 16, 18, connect to the social networking platform social network, 2, using a computing device. Businesses create profiles on the social network that includes information about the business. For example, a restaurant may build a profile that includes hours, drink menu, food menu or promotions.

Users of the social networking platform social network can connect with other users of the social networking platform social network for a variety of reasons including for example, a shared common interest, a similar location, etc. A user, 20, can connect with other users, 22, 24, 26, 28, on an individual basis. Or a user, 20, can simply connect with contacts from other social networks, 30.

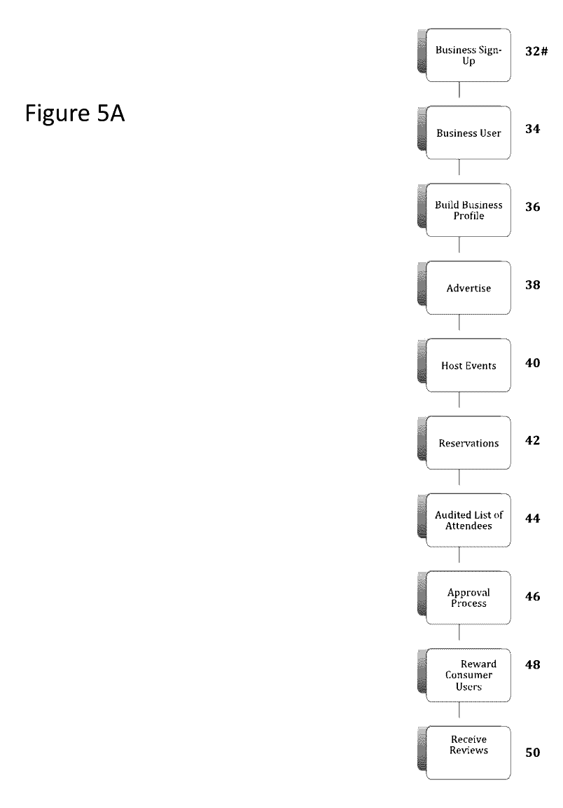

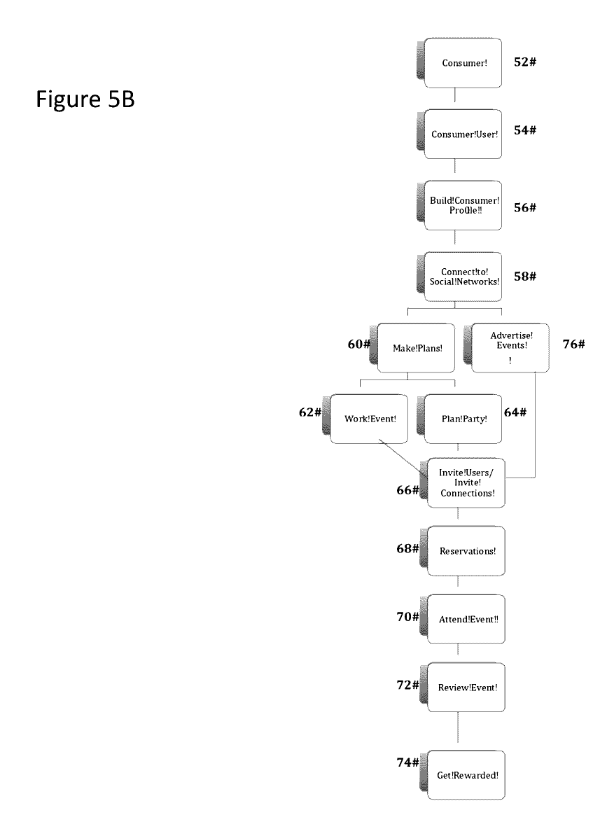

Referring to FIG. 5A, the social networking platform social network allows business to create profiles, host events or parties, and reward frequent customers. A business interested in the social networking platform network, 32 would sign up for the social network service and thus become a business user, 34. Once connected, business can create and build a business profile, 36, where they then can advertise the business and advertise for events or promotions, 38. Through advertising businesses can attract new clientele and increase profits. Businesses can also host specific parties or events, 40, where they are able to invite existing customer users and incentivize customer users to bring in new customers. Businesses are also able to access a built in reservation system, 42, where users can make reservations for existing events and also reserve space for user-created events. After each event, the social networking platform social network system provides the participating business with an audited list of attendees, 44. The list also includes other information, such as, the money spent by social networking platform consumer users. Businesses are then able to partake in an approval process, 46, where they then can reward social networking platform customer users, 48, for attending certain events, bringing in new customers, making a dinner reservation, etc. Businesses are also able to allow for reviews, 50, which is both beneficial to the consumer user and the business user.

On the consumer side, FIG. 5B, the social networking platform social network allows for a consumer, 52, to sign up as a social networking platform social network consumer user, 54. Then, the new user is able to build their consumer profile, 56, where they can share information like biographical facts, specific interests, or hobbies. Consumer users are also capable of connecting all their top social networks, 58, like Facebook, Twitter, LinkedIn, etc. Consumer users are able to then explore their social networking platform options. Users can make their own plans, 60, schedule a work event, 62, or plan a party, 64. Whatever the occasion or event, users can invite connections from the social networking platform social networking platform or they can invite connections from their other connected social networks, 66. Users then can reserve the proper venue, 68, attend the event, 70 review their event to help benefit other users and the business venue, 72. Ultimately, users can then get rewarded, 74, for hosting the events, spending, money bringing in new customers to specific venue, etc.

If users are not interested in hosting their own party but looking to attend an event in town, social networking platform provides user's to view business's advertised events, 76. Then users are able to invite their friends to the advertised event, 66, or attend solo. Similarly to hosting an event, users can make a reservation or RSVP to the advertised event, 68, then attend the event, 70, review the event, 72, and get rewarded 74.

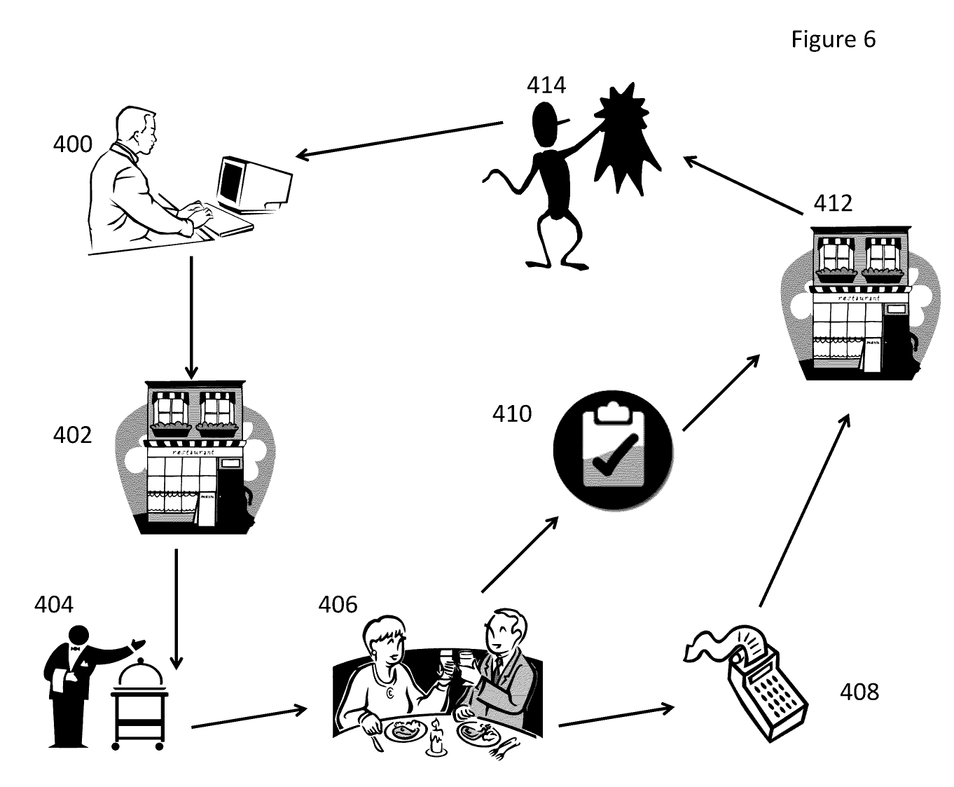

FIG. 6 is a depiction of one embodiment of the invention as used by a social networking platform consumer member when dining at a social networking platform business user and receiving rewards from the business user. The social networking platform consumer member 400 plans an event at a social networking platform business user location 402. The consumer member signs into his social networking platform social networking account 400 where the consumer member can plan an event, make reservations, or attend an advertised social networking platform business event at a business user location 402. The consumer user then attends the event, where they check in at the social networking platform business member location, 402. The consumer user will then check in with a business user hostess, manager, or waiter 404. The business user hostess, manager, or waiter will check the consumer user in and may offer the consumer user additional rewards/discounts. If the consumer user has stored rewards from the business user, the consumer user is able to apply those awards immediately. The consumer user is then able to enjoy the event, party, reservation, etc. 406. The hostess, manager, or waiter can then review the transactions made by the consumer user 408. The consumer users after attending their social event 406 can then share feedback with the business user in the form of reviews 410. This information, including an audited list of attendees, amount spent, and consumer user reviews are tracked and stored by the business social networking platform account 412. The business user is then able to allocate rewards 414, both monetary and non-monetary, to the consumer user 400. The consumer user rewards are also tracked and stored by the consumer social networking platform account.

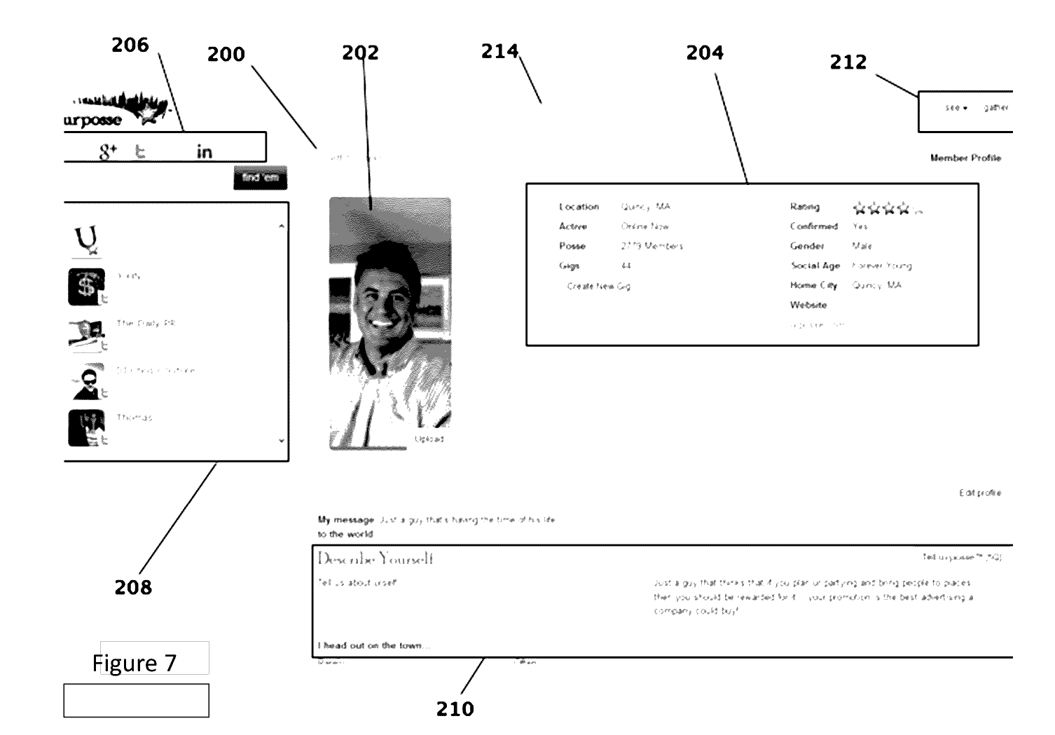

FIG. 7 is representation of the consumer user profile page. In some embodiments, the consumer user signs-up for the social networking platform service. They are then prompted to create a profile 214 that displays the consumer user's name, 200, a picture of the consumer user, 202 and specific personal information, 204, like gender, location, home city, birthday, etc. The consumer user's profile also provides an area where the consumer user can describe himself 210, events he likes to attend, past events he has attended, etc. The profile page is also where the consumer user connects to his other social media accounts, 206 like Facebook®, Twitter®, Linkedin®, etc. A consumer user can connect with his friends from outside the social networking platform network or choose to make new connections with members of social networking platform. All connections are displayed on the profile page, 208 which allows for the consumer user to easily contact members to invite them to hosted events or make plans. The consumer user profile also provides also provides links to easily view upcoming events hosted by businesses, 212.

In conclusion, herein is presented a computer-implemented system and method for a rewards-based social networking platform. The invention is illustrated by example in the flow diagrams and figures, and throughout the written description. It should be understood that numerous variations are possible, while adhering to the inventive concept. Such variations are contemplated as being a part of the present invention.

What is claimed is:

1. A computer-implemented method for a social network reward-based platform, the method comprising the steps of:
generating, via a hardware computing device, at least one person wherein the at least one person is a consumer user;
creating a consumer user profile including:
receiving a plurality of data inputs in a network,
storing the plurality of data inputs in a network,
displaying at least a portion of the plurality of data on the user profile page;
connecting at least one social networking account of the consumer user's;
receiving information that connects the consumer user via a social network service;
receiving information of consumer user activity at a reward-based program site, the consumer user being a member of one or more social networking sites;
computing a reward based system where the consumer user is rewarded for attending a social event or planning a social event;
determining a location of the consumer user using at least one global positioning system and data input from the user;
displaying at least one social event on at least one of the profile pages and a social event page,
generating, via a hardware computing device, at least one business wherein the at least one business is a business user;
creating a business user profile including:
receiving a plurality of data inputs in a network,
storing the plurality of data inputs in a network,
displaying at least a portion of the plurality of data on the business user profile page;
computing a reward based system where the business user advertises rewards for the consumer user to attend a social event or plan a social event;
receiving an event check-in from at least one of the global positioning system and the consumer user;
allocating a reward to the consumer user;
receiving at least one review from the consumer user regarding the business user, the event attended or the event hosted;
displaying at least one review from the consumer user on at least one of the business user profile, at least one of an event details page;
distributing the at least one comment to at least one social networking account associated with the user.

2. The method of claim 1, wherein the plurality of data inputs from the consumer user comprises of the consumer user's name, e-mail address, gender, date of birth, consumer user interests, description of consumer user, consumer user connections (posse), consumer user events (gigs).

3. The method of claim 1, wherein the plurality of data inputs from the business user comprises of the business's information including business name, contact information, description of the business, menus, business user connections, business user events.

4. The method of claim 1, wherein the reward based system allows business user an allocation amount comprising of a percentage of sales to allocate to the consumer user.

5. The method of claim 1 wherein the reward based system comprises the consumer user to receive the allocation amount through a configuration consumer user interface.

6. The method of claim 1, wherein the at least one social networking account is one of Facebook®, Twitter®, Linkedin®.

7. The social event page of claim 1, wherein the selection of the social event is at least in part based on a location of the event, or an interest of the user, or both.

8. The method of claim 1, and further comprising displaying event-specific information on the social event page.

9. The method of claim 1 and further comprising displaying names of other consumer users checked-in to an event.
